(19) United States
(12) Patent Application Publication
(10) Pub. No.: US 2008/0190250 A1
(43) Pub. Date: Aug. 14, 2008

(54) Heated dental pliers

(76) Inventor: Donald Nevin, Woodbury, NY (US)

Correspondence Address: EPSTEIN DRANGEL BAZERMAN & JAMES, LLP, 60 EAST 42ND STREET, SUITE 820, NEW YORK, NY, 10165, US

(21) Appl. No.: 11/704,436

(22) Filed: Feb. 8, 2007

(51) Int. Cl. B25B 7/02

(52) U.S. Cl. 81/421

(57) ABSTRACT

The pliers, preferably in the form of dental pliers, include first and second members. Each of the members includes a handle portion and a jaw portion. The members are pivotally connected for movement of the jaw portions between remote and proximate positions. One of the jaw portions has a recess within which a nichrome heating element is situated. First and second wires extend into the recess and are connected to the heating element. The wires are connected to a variable power source to electrically energize the heating element such that the jaw portion of the pliers with the heating element is heated to the desired degree.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A “SEQUENCE LISTING”, A TABLE, OR A COMPUTER PROGRAM LISTING APPENDIX SUBMITTED ON COMPACT DISC

Not Applicable

### BACKGROUND OF THE INVENTION

1. Field of the Invention

The present invention relates to a tool, particularly but not exclusively to pliers used for dental procedures, which include an electrically heated jaw portion.

2. Description of Prior Art Including Information Disclosed Under 37 CFR 1.97 and 1.98

Pliers of various configurations are known in the art for use in a wide variety of different applications, including a variety of dental procedures. Some dental procedures require the application of heat at the same time as force is applied by the pliers.

Certainly it is possible to heat one or more of the jaw portions of the metal pliers members using a flame or other external heat source. However, heating the pliers in that fashion does not permit the accurate control of the temperature and may therefore be dangerous to the patient and/or the dentist.

It is, therefore, a prime object of the present invention to provide electrically heated dental pliers that permit accurate control of the temperature.

It is another object of the present invention to provide electrically heated dental pliers that are safe to use for the patient and the dentist.

It is another object of the present invention to provide heated dental pliers that include a recess in one jaw portion a heating element is received.

It is another object of the present invention to provide electrically heated dental pliers that can be disconnected from the power source for sterilization.

It is another object of the present invention to provide electrically heated dental pliers formed of relatively inexpensive and easily assembled parts.

It is another object of the present invention to provide electrically heated dental pliers formed of parts that function together reliably for a long useful life.

### BRIEF SUMMARY OF THE INVENTION

In accordance with the present invention, pliers is provided including first and second members. Each of the members includes a handle portion and a jaw portion. Means are provided for pivotally connecting the members for movement of the jaw portions between remote and proximate positions. One of the jaw portions has a recess. First and second wires extend into the recess. A heating element is situated in the recess. The heating element is connected to the wires to form a circuit. Means is provided for electrically energizing the circuit to heat the heating element and the jaw portion in which it is mounted.

A channel is provided extending at least partially within the handle portion associated with the jaw portion with the heating element.

The pliers further include first connector means situated on the handle portion associated with the one jaw portion with the heating element. The first connector means is operably electrically connected to the first and second wires. Preferably, the first connector means is situated proximate the end of the handle portion associated with the jaw portion carrying the heating element.

Second connector means are also provided. The second connector means is operably electrically connected to the energizing means. The first and second connector means releasably inter-engage to connect the wires to the energizing means.

The energizing means preferably takes the form of a variable power source.

The wires are preferably situated within an insulated cable.

The first connector means is preferably situated on the handle portion associated with the jaw portion having the heating element and is operably electrically connected to the first and second wires. Preferably, the first connector means is situated proximate the end of that handle portion.

### BRIEF DESCRIPTION OF THE SEVERAL VIEWS OF DRAWINGS

To these and to such other objects that may hereinafter appears, the present invention relates to heated dental pliers as described in detail in the following specification and recited in the annexed claims, taken together with the accompanying drawings, in which like numerals refer to like parts and in which:

FIG. 1 is an environmental view showing the pliers of the present invention as they might be used by a dentist performing a procedure on a patient;

FIG. 2 is an isometric view showing the pliers and power source of the present invention with the jaw portions of the pliers in the proximate position;

FIG. 3 is an elevation view of the pliers, with the jaw portions in the remote position, and the connectors exploded;

FIG. 4 is an enlarged elevation view of the jaw portions of the pliers;

FIG. 5 is a cross-sectional view taken along line 5-5 of FIG. 3; and

FIG. 6 is an elevation view taken along line 6-6 of FIG. 4.

### DETAILED DESCRIPTION OF THE INVENTION

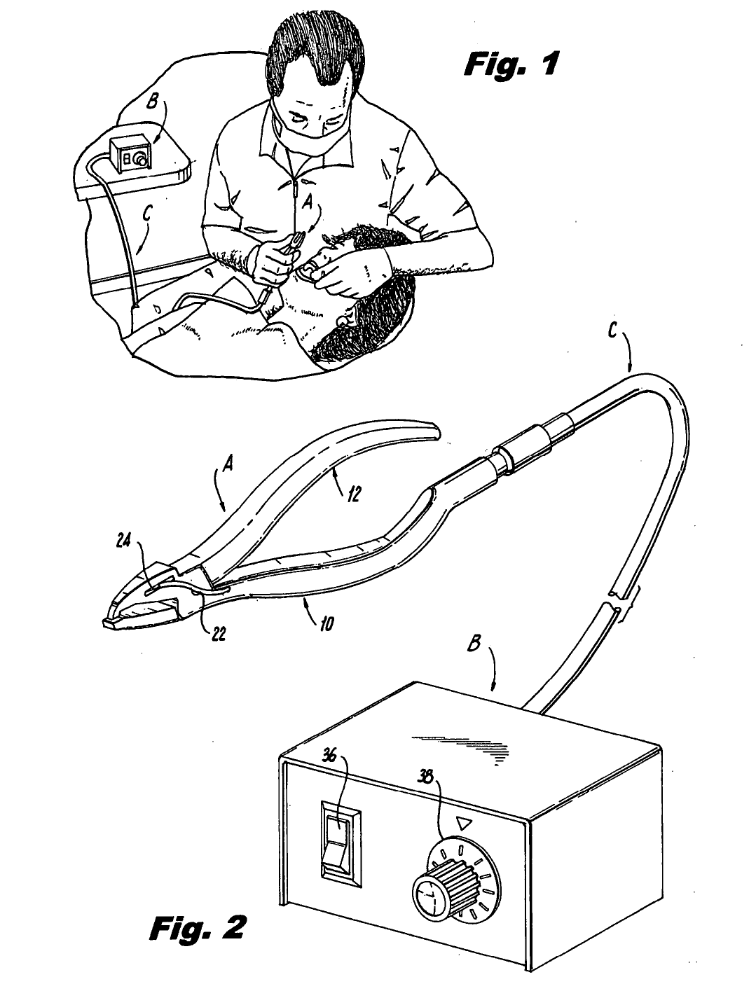

As seen in FIG. 2, the present invention includes electrically heated pliers, generally designated A, and a variable power source, generally designated B, connected to pliers A by an insulated cable, generally designated C. FIG. 1 illustrates how the invention would be used by a dentist to perform a procedure on a patient.

Pliers A, as shown in FIGS. 3 and 4, include first and second members 10, 12 made of heat conductive metal material, such as steel. Members 10 and 12 are connected for relative movement by a pin or shaft 14, as is conventional.

Each of the members 10, 12 consists of a handle portion 10a, 12a and a jaw portion 10b, 12b. The members pivot about shaft 14 such that the jaw portions 10b, 12b move between a proximate position, shown in FIG. 2, and a remote position, shown in FIGS. 3 and 4. The shapes of the individual jaw portions 10b, 12b of the pliers may differ in accordance with the particular application for which the tool is designed. In the preferred embodiment illustrated in the drawings, jaw portion 10b includes a tip 13 bent inwardly towards the interior surface 15 of jaw portion 12b so as to concentrate the force applied by jaw portion 10b on jaw portion 12b in a defined area.

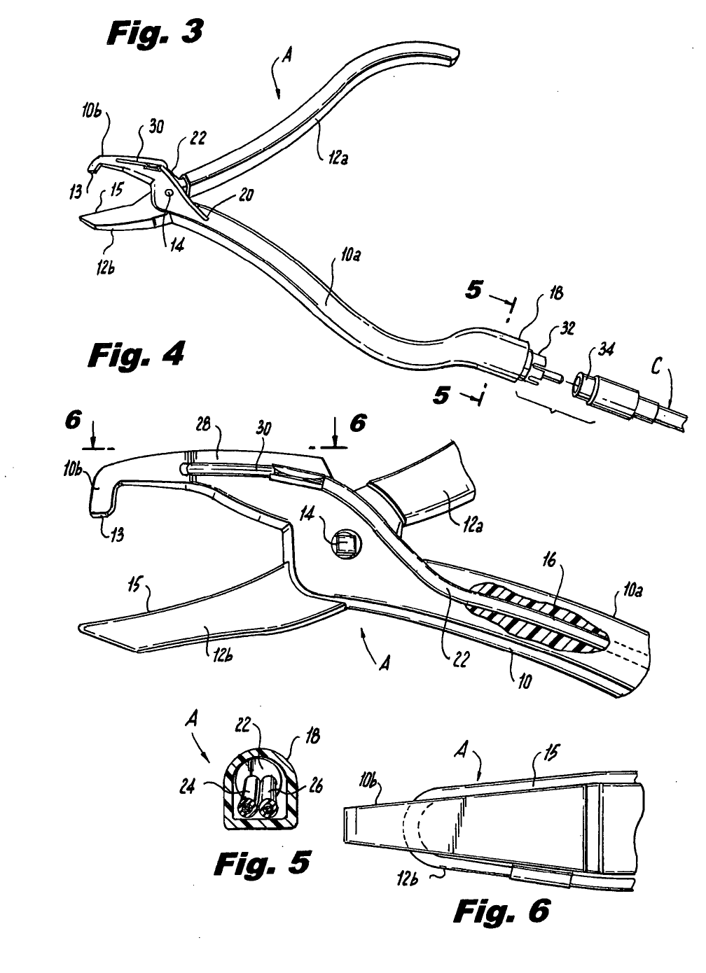

As seen in FIGS. 3 and 4, handle portion 10a of member 10 has an internal channel 16 that extends from the end 18 of the handle portion to an opening 20 in the wall of the handle portion. Opening 20 is spaced a short distance from shaft 14. An insulated cable 22, including two wires 24, 26 (see FIG. 5), extends from end 18 of member 10, through channel 16 and out opening 20. The cable then runs along the exterior surface of the member into a recess 28. A heating element 30 is situated in recess 28. Wires 24 and 26 of cable 22 are connected to the opposite ends of heating element 30. Preferably, heating element 30 is a nichrome resistance wire section.

Wires 24, 26 of cable 22 are connected to cable C thru connectors 32 and 34. Connector 32 is a male connector. Connector 34 is a female connector. Using inter-engaging connectors in this manner permits the pliers to be disconnected from cable C for sterilization purposes.

Power source B provides current thru cable C, connectors 32, 34, and cable 22 to heating element 30, when activated by on-off switch 36. The amount of current provided to the heating element, and hence the amount of heat generated by the heating element, is varied by rotating dial 38 on the power source.

The heat generated by element 30 travels from recess 28 along jaw portion 10b to tip 13. Accordingly, the heat can be applied by the dentist in the precise location in the patient's mouth required by the dental procedure. For example, the pliers of the present invention may be used to increase the retention potential of a dental appliance by emphasizing the retentive undercuts gingival to the contact points of the appliance.

It will now be appreciated that the present invention relates to electrically heated pliers, preferably dental pliers, including first and second members. Each of the members includes a handle portion and a jaw portion. The members are pivotally connected for movement of the jaw portions between remote and proximate positions. One of the jaw portions has a recess within which a nichrome heating element is situated. First and second wires extend into the recess and are connected to the heating element. The heating element is electrically energized by a variable power source connected to the wires such that the jaw portion carrying the heating element is heated to the desired degree.

While only a single of preferred embodiment of the present invention have been disclosed for purposes of illustration, it is obvious that many modifications and variations could be made thereto. It is intended to cover all of those modifications and variations which fall within the scope of the present invention, as defined by the following claims.

I claim:

1. A pliers comprising first and second members, each of said members comprising a handle portion and a jaw portion, means for pivotally connecting said members for movement of said jaw portions between remote and proximate positions, one of said jaw portions comprising a recess, first and second wires extending into said recess, a heating element situated in said recess, said heating element being connected to said wires to form a circuit, and means for electrically energizing said circuit to heat said heating element and said one jaw portion.

2. The pliers of claim 1 further comprising a channel extending at least partially within said handle portion associated with said one jaw portion.

3. The pliers of claim 1 further comprising first connector means situated on said handle portion associated with said one jaw portion and operably electrically connected to said first and second wires.

4. The pliers of claim 3 wherein said first connector means is situated proximate the end of said handle portion associated with said one jaw portion.

5. The pliers of claim 3 further comprising second connector means operably electrically connected to said energizing means.

6. The pliers of claim 5 wherein said first and second connector means releasably inter-engage to connect said wires to said energizing means.

7. The pliers of claim 1 wherein said energizing means comprise a variable power source.

8. The pliers of claim 1 wherein said wires are situated within an insulated cable.

9. The pliers of claim 2 further comprising first connector means situated on said handle portion associated with said one jaw portion and operably electrically connected to said first and second wires.

10. The pliers of claim 9 wherein said first connector means is situated proximate the end of said handle portion associated with said one jaw portion.

11. The pliers of claim 10 further comprising second connector means operably electrically connected to said energizing means.

12. The pliers of claim 11 wherein said first and second connector means releasably inter-engage to connect said wires to said energizing means.

13. The pliers of claim 1 wherein said heating element comprises a nichrome resistance wire section.
